(19) United States
(12) Patent Application Publication
(10) Pub. No.: US 2006/0238476 A1
(43) Pub. Date: Oct. 26, 2006

(54) Display panel, display device having the same and method of driving the same

(75) Inventors: Cheol-Woo Park, Suwon-si (KR); Kyoung-Ju Shin, Yongin-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/367,145

(22) Filed: Mar. 3, 2006

(30) Foreign Application Priority Data
Apr. 26, 2005 (KR) 2005-34603

(51) Int. Cl. G09G 3/36

(52) U.S. Cl. 345/92

(57) ABSTRACT

A display may include switching circuitry in pixel regions to implement impulse driving. A first pixel region may include switching circuitry to provide a data voltage to the first pixel region during a first portion of a frame, and to provide an impulse voltage to the first pixel region during a second portion of the frame. In some embodiments, a display panel may include a liquid crystal capacitor, a switching element, a storage capacitor, an impulse gate line and an impulse driving element. The liquid crystal capacitor may be in a region defined by adjacent gate and data lines. The switching element transmits a data voltage to the liquid crystal capacitor based on a gate voltage. The data voltage is from the data line, and the gate voltage is from the gate line. The storage capacitor is electrically connected to the liquid crystal capacitor. The impulse gate line transmits an impulse gate signal. The impulse driving element transmits a common voltage to the liquid crystal capacitor based on the impulse gate signal. The common voltage is applied to the storage capacitor. The driving margin may be increased, and a display quality of a moving image improved.

### CROSS REFERENCE TO RELATED APPLICATION

The present application claims priority from Korean Patent Application No. 2005-34603, filed on Apr. 26, 2005, the disclosure of which is hereby incorporated herein by reference in its entirety.

### BACKGROUND OF THE INVENTION

1. Field of the Invention

The present disclosure relates to a display panel, a display device having the display panel and a method of driving the display panel. More particularly, the present disclosure relates to a display panel capable of impulsive driving, a display device having the display panel and a method of driving the display panel.

2. Description of the Related Art

Screen size and performance of liquid crystal display (LCD) devices have been enhanced so that LCD devices are more competitive with other display devices such as cathode ray tube (CRT) devices, plasma display panel (PDP) devices, and other devices. Some characteristics of LCD devices that are important to performance include viewing angle, color reproducibility, capability of displaying a moving image, and other characteristics.

### SUMMARY OF THE INVENTION

Systems and techniques described herein may provide for enhanced performance of a display such as an LCD display device. Particularly, the display of moving images may be enhanced by implementing impulse driving in a display.

In general, in one aspect, a display panel capable of impulsive driving is provided.

In another aspect, the current disclosure also provides a display device having the display panel.

In another aspect, the current disclosure also provides a method of driving the display panel.

A display panel in accordance with one aspect of the present invention includes a liquid crystal capacitor, a switching element, a storage capacitor, an impulse gate line and an impulse driving element. The liquid crystal capacitor is in a region defined by adjacent gate and data lines. The switching element transmits a data voltage to the liquid crystal capacitor based on a gate voltage. The data voltage is from the data line, and the gate voltage is from the gate line. The storage capacitor is electrically connected to the liquid crystal capacitor. The impulse gate line transmits an impulse gate signal. The impulse driving element transmits a common voltage to the liquid crystal capacitor based on the impulse gate signal. The common voltage is applied to the storage capacitor.

The impulse driving element has a gate electrode coupled to the impulse gate line, a source electrode coupled to the common of the storage capacitor and a drain electrode coupled to the liquid crystal capacitor.

The display panel may further include an impulse line to which the impulse voltage is applied. The impulse line is generally parallel to the data line. The impulse driving element transmits the impulse voltage to the liquid crystal capacitor in accordance with the activation of the impulse gate line. Here, the impulse driving element has a gate electrode coupled to the impulse gate line, a source electrode coupled to the impulse line and a drain electrode coupled to the liquid crystal capacitor.

A display panel in accordance with another aspect of the present invention includes an organic light emitting element, an impulse gate line, a driving element, a switching element and an impulse driving element. The organic light emitting element is in a region defined by adjacent gate and data lines and a power voltage line. The impulse gate line transmits an impulse gate signal. The driving element drives the organic light emitting element. The switching element transmits a data voltage to the driving element based on a gate voltage. The data voltage is from the data line. The gate voltage is from the gate line. The impulse driving element transmits a common voltage to the driving element based on the impulse gate signal.

A display device in accordance with one embodiment of the present invention includes a voltage generator circuit, a data driver circuit, a control circuit, a gate driver circuit, an impulse driver circuit and a display panel. The voltage generator circuit outputs an impulse voltage. The data driver circuit outputs a data voltage. The control circuit outputs a first control signal and a second control signal based on a driving frequency. The second control signal is delayed with respect the first control signal by a delay amount. The gate driver circuit outputs a gate signal based on the first control signal. The impulse driver circuit outputs an impulse gate signal based on the second control signal. The display panel displays a normal gray-scale corresponding to the data voltage based on the gate signal during a first period of a frame, and displays an impulse gray-scale corresponding to the impulse voltage based on the impulse gate signal during a second period of the frame.

A method of driving a display device in accordance with one embodiment of the present invention is provided as follows. A data signal is outputted. An impulse signal is outputted. A gate signal is outputted. A normal gray-scale corresponding to the data signal is displayed based on the gate signal during a first period of a frame. An impulse gate signal that is delayed with respect to the gate signal by a delay amount is outputted. An impulse gray-scale corresponding to the impulse signal is displayed based on the impulse gate signal during a second period of the frame.

In general, in another aspect, a display apparatus may comprise a first pixel region of the display apparatus, the first pixel region comprising switching circuitry to implement impulse driving. The switching circuitry may be configured to provide a data voltage to the first pixel region during a first portion of a frame, and further configured to provide an impulse voltage to the first pixel region during a second portion of the frame. The display apparatus may further comprise a second pixel region including different switching circuitry. The different switching circuitry may be configured to provide a different data voltage to the second pixel region during the first portion of the frame. The different switching circuitry may be further configured to provide the impulse voltage to the second pixel region during the second portion of the frame.

The switching circuitry may comprise a data switch and an impulse switch separate from the data switch. The data switch may comprise a thin film transistor, and the impulse switch comprises a different thin film transistor. The first pixel region may comprise a liquid crystal pixel region, and the switching circuitry is configured may provide the data voltage to the first pixel region during the first portion of the frame by transmitting the data voltage to a liquid crystal capacitor. The switching circuitry may be configured to provide the impulse voltage to the first pixel region during the second portion of the frame by transmitting the impulse voltage to the liquid crystal capacitor.

According to the present invention, impulsive driving may be performed without increasing the driving speed of the display device. The driving margin may be increased, and a display quality of a moving image may be improved.

### BRIEF DESCRIPTION OF THE DRAWINGS

The above and other advantages of the present invention will become more apparent by describing in detail embodiments thereof with reference to the accompanying drawings, in which:

FIG. 1 is a circuit diagram showing a unit pixel of a display panel, in accordance with some embodiments of the present invention;

FIG. 2 is a circuit diagram showing a unit pixel of a display panel in accordance with another embodiment of the present invention;

FIG. 3 is a block diagram showing a liquid crystal display (LCD) device in accordance with some embodiments of the present invention;

FIG. 4 is a plan view showing a display panel of the LCD device shown in FIG. 3;

FIG. 5 is a plan view showing a display panel in accordance with another embodiment of the present invention;

FIGS. 6A to 6E are timing diagrams showing a method of impulsive driving in accordance with one embodiment of the present invention;

FIGS. 7A to 7E are timing diagrams showing a method of impulsive driving in accordance with another embodiment of the present invention;

FIG. 8 is a circuit diagram showing a unit pixel of a display panel in accordance with another embodiment of the present invention; and

FIG. 9 is a block diagram showing an organic light emitting display (OLED) device in accordance with another embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully describe the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. Further, a “first” or other numbered element does not imply that “second” or additional elements are needed.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular, exemplary embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations of idealized embodiments (and related structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Implanted species may also move outside the implant region due to (for example) diffusion. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

As noted above, accurate display of moving images may be important in some display applications. Systems and techniques described herein provide for impulse driving of display elements, for improved moving image display. In impulsive driving, a black (or other reference) image may be inserted after a normal image so that the black and normal images are displayed in one frame. For some existing impulse driving systems, the driving frequency is increased to provide for the insertion of the reference image; for example to a frequency of more than about 120 Hz. However, when the driving frequency of an LCD device is increased, the driving margin of the LCD device with respect to a capacitance of a liquid crystal cell is decreased.

Systems and techniques provided herein may allow for more efficient impulse driving by providing impulse circuitry associated with the display pixel regions. Embodiments described herein may thus allow for improved driving margin without the need to increase the driving frequency_{[LGGI]}.

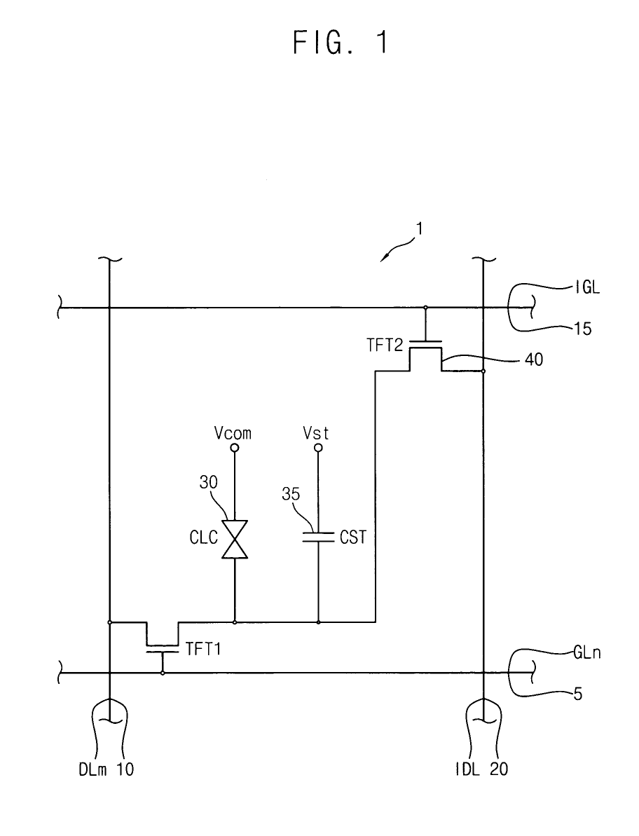

FIG. 1 is a circuit diagram showing a unit pixel of a display panel, according to some embodiments. Referring to FIG. 1, a unit pixel 1 is defined by a gate line GLn 5, a data line DLm 10, an impulse gate line IGL 15 and an impulse data line IDL 20. Unit pixel 1 includes a first switching element TFT1 25, a liquid crystal capacitor CLC 30, a storage capacitor CST 35 and a second switching element TFT2 40. Although first switching element TFT1 25 and second switching element TFT2 40 are shown as thin film transistors (TFTs), they may incorporate different switching mechanisms.

First switching element TFT1 25 includes a first gate electrode electrically connected to gate line GLn 5, a first source electrode electrically connected to data line DLm 10, and a first drain electrode electrically connected to liquid crystal capacitor CLC 30.

Liquid crystal capacitor CLC 30 includes a first electrode electrically connected to first switching element TFT1 25, and a second electrode receiving a common voltage Vcom.

Storage capacitor CST 35 includes a first electrode electrically connected to the first switching element TFT1 25 and the liquid crystal capacitor CLC 30, and a second electrode receiving the storage common voltage Vst.

Second switching element TFT2 40 includes a second gate electrode electrically connected to impulse gate line IGL 15, a second source electrode electrically connected to impulse data line IDL 20, and a second drain electrode electrically connected to liquid crystal capacitor CLC 30 and storage capacitor CST 35.

Unit pixel 1 described above may be operated as follows.

When a gate signal is applied to the first gate electrode of first switching element TFT1 25 through gate line GLn 5, first switching element TFT1 25 is turned on so that a data voltage that is applied to the first source electrode of first switching element TFT1 25 through data line DLm 10 is stored in liquid crystal capacitor CLC 30 and storage capacitor CST 35.

In response, unit pixel 1 displays a normal gray-scale corresponding to the data voltage, based on an electric charge stored in liquid crystal capacitor CLC 30.

After a predetermined time period, an impulse gate signal is applied to impulse gate line IGL 15. When the impulse gate signal is applied to impulse gate line IGL 15, the second switching element TFT2 is turned on so that the impulse voltage applied to impulse data line IDL 20 is stored in liquid crystal capacitor CLC 30 and the storage capacitor CST. The impulse voltage for impulsive driving is a data voltage corresponding to a low luminance, such as a black image or a gray image.

When the impulse voltage is stored in liquid crystal capacitor CLC 30, unit pixel 1 displays an impulse gray-scale (for example, a black gray-scale) corresponding to the impulse voltage. Further, when second switching element TFT2 40 of unit pixel 1 is turned on, the electric charge stored in liquid crystal capacitor CLC 35 formed by the data voltage is discharged_{[LGG2]}.

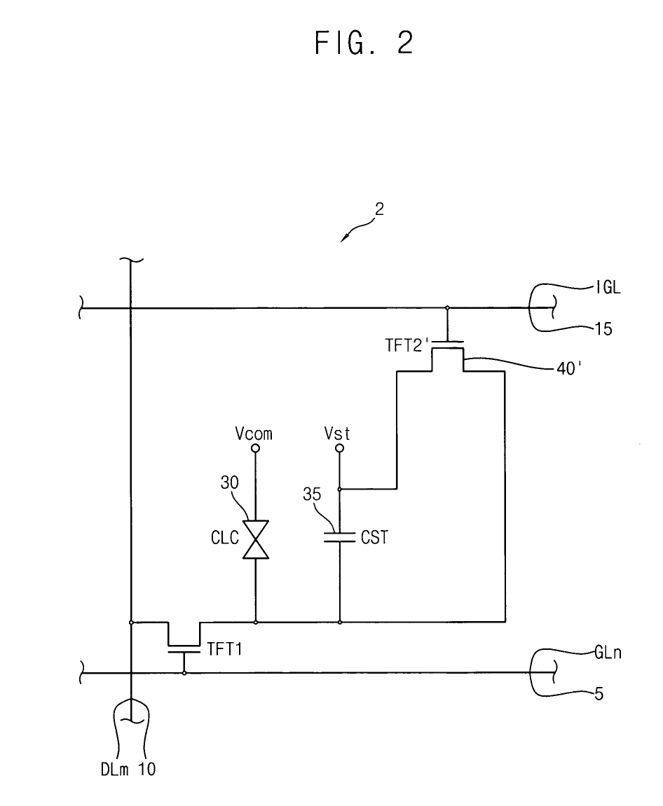

FIG. 2 is a circuit diagram showing a unit pixel 2 of a display panel in accordance with another embodiment of the present invention. Unit pixel 2 of FIG. 2 differs from pixel 1 of FIG. 1 by the omission of an impulse data line. Thus, the same reference numerals will be used to refer to the same or like parts as those described with reference to FIG. 1, and any further explanation concerning the above elements will be omitted.

Referring to FIG. 2, unit pixel 2 is defined by gate line GLn 5, data line DLm 10 and impulse gate line IGL 15. Unit pixel 2 includes first switching element TFT1 25, liquid crystal capacitor CLC 30, storage capacitor CST 35, and a second switching element TFT2′ 40′, which differs from TFT2 40 of FIG. 1 in that it is not connected to an impulse data line IDL 20. Like TFT2 40 of FIG. 1, TFT2′ 40′ is shown as a thin film transistor, but may implement different or additional switching mechanisms Second switching element TFT2′ 40′ includes a second gate electrode, a second source electrode and a third drain electrode. The second gate electrode is electrically connected to impulse gate line IGL 15. The second source electrode is electrically connected to a common voltage line (not shown) receiving a storage common voltage Vst. The storage common voltage Vst and a common voltage Vcom are applied to the common voltage line (not shown). The third drain electrode is electrically connected to liquid crystal capacitor CLC 30 and storage capacitor CST 35.

In impulse driving, when the storage common voltage Vst applied to storage capacitor CST 35 is applied to the second source electrode of second switching element TFT2′ 40′, an LCD device operates in a mode referred to as a “normally black” mode. In the normally black mode, when a voltage is not applied to unit pixel 2 (e.g., by applying a gate voltage to gate line GLn 5 and a data voltage to data line DLm 10), a black gray-scale is displayed_{[LGG3]}.

Unit pixel 2 described above may be operated as follows.

When a gate signal is applied to the first gate electrode of first switching element TFT1 25 through gate line GLn 5, first switching element TFT1 25 is turned on. In response, a data voltage applied to the first source electrode of first switching element TFT1 25 through data line DLm 10 is stored in liquid crystal capacitor CLC 30 and storage capacitor CST 35. Unit pixel 2 displays a normal gray-scale corresponding to the data voltage based on an electric charge stored in liquid crystal capacitor CLC 30.

After a pre-determined time, an impulse gate signal is applied to the impulse gate line IGL 15, turning on second switching element TFT2′ 40′. In response, the storage common voltage Vst that is applied to storage capacitor CST 35 is stored in liquid crystal capacitor CLC 30 and storage capacitor CST 35. That is, the storage common voltage Vst functions as the impulse voltage.

When the storage common voltage Vst is stored in liquid crystal capacitor CLC 30, unit pixel 2 displays an impulse gray-scale (for example, a black gray-scale) corresponding to the storage common voltage Vst. When second switching element TFT2′ 40′ of the unit pixel P2 is turned on, the electric charge stored in liquid crystal capacitor CLC 30 formed by the storage common voltage Vst is discharged.

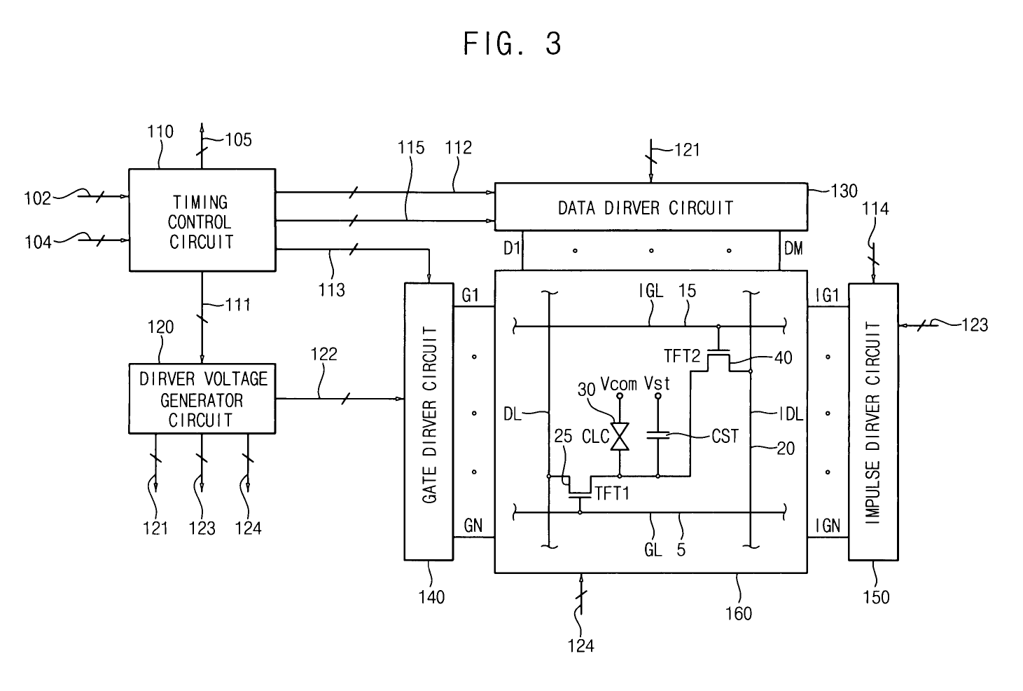

FIG. 3 is a block diagram showing a liquid crystal display (LCD) device, according to some embodiments. Referring to FIG. 3, an LCD device includes a timing controller circuit 110, a driving voltage generator circuit 120, a data driver circuit 130, a gate driver circuit 140, an impulse driver circuit 150 and an LCD panel 160.

Timing control circuit 110 outputs a first control signal over a bus 111, a second control signal over a bus 112, a third control signal over a bus 113 and a fourth control signal over a bus 114 based on control signals received on a bus 102 having a driving frequency. In some embodiments, control signals are received on bus 102 from outside of the LCD device. In the LCD device shown in FIG. 3, the driving frequency is about 60 Hz to about 75 Hz; however, other frequencies may be used.

The control signals on bus 102 include a main clock signal MCLK, a horizontal synchronization signal HSYNC, a vertical synchronization signal VSYNC and a data enable signal DE.

The first control signal on bus 111 includes the main clock signal MCLK. Timing control circuit 110 provides the first control signal to driving voltage generator circuit 120 over bus 111.

The second control signal on bus 112 includes a horizontal start signal STH and a load signal TP. Timing control circuit 110 provides the second signal to data driver circuit 130 over bus 112.

The third control signal on bus 113 includes a first scan start signal STV1, a first scan clock signal CPV1 and a first output enable signal OE1. Timing control circuit 110 provides the third control signal to gate driver circuit 140 over bus 113.

Fourth control signal 114 includes a second scan start signal STV2, a second scan clock signal CPV2 and a second output enable signal OE2. Timing control circuit 110 provides the fourth control signal 114 to impulse driver circuit 150.

Driving voltage generator circuit 120 generates driving voltages for driving data driver circuit 130, gate driver circuit 140, impulse driver circuit 150 and LCD panel 160 based on the first control signal on bus 111. In particular, driving voltage generator circuit 120 provides a reference gray-scale voltage on bus 121 to data driver circuit 130, first gate voltage on bus 122 to the gate driver circuit 140,and second gate voltage on bus 123 to impulse driver circuit 150. Driving voltage generator circuit 120 applies a common voltage Vcom for a liquid crystal capacitor CLC and a storage common voltage Vst for the storage capacitor CST to LCD panel 160. Alternatively, when LCD panel 160 includes a unit pixel such as pixel 1 of FIG. 1, driving voltage generator circuit 120 also applies an impulse voltage to an impulse data line.

Data driver circuit 130 generates analog type data voltages D1, D2, . . . DM based on the second control signal received on bus 112, image data received on bus 115 and the reference gray-scale voltage received on bus 121. Data driver circuit 130 applies the analog type data voltages D1, D2, . . . DM to the data lines DL of LCD panel 160.

Gate driver circuit 140 generates gate signals G1, G2, . . . GN based on third control signal received on bus 113 from timing control circuit 110 and first gate voltages received on bus 122 from driving voltage generator circuit 120. Gate driver circuit 140 applies the gate signals G1, G2, . . . GN to the gate lines GL of LCD panel 160.

Impulse driver circuit 150 generates impulse gate signals IG1, IG2, . . . IGN based on fourth control signal 114 from the timing control circuit 110 and second gate voltages 123 from driving voltage generator circuit 120. Impulse driver circuit 150 applies the impulse gate signals IG1, IG2, . . . IGN to the impulse gate lines of LCD panel 160.

The second scan start signal STV2 of the third control signal on bus 113 is delayed with respect to the first scan start signal STV1 of the fourth control signal on bus 114.by a pre-determined delay amount. That is, the second scan start signal STV2 is output after the first scan start signal STV1 is output, and a difference between the first and second start signals STV1 and STV2 is referred to as the delay amount. The delay amount is shorter than one frame.

Each of the impulse gate signals IG1, IG2, . . . IGN initiated after the second scan start signal STV2 is delayed with respect to the gate signals G1, G2, . . . GN initiated after the first scan start signal STV1 by the delay amount. Therefore, a normal image that is displayed using the data voltage and an impulse image that is displayed using the impulse voltage are displayed on LCD panel 160 in one frame.

LCD panel 160 includes a first substrate, a second substrate corresponding to the first substrate and a liquid crystal layer interposed between the first and second substrates. LCD panel 160 includes a plurality of unit pixels, such as pixel 1 of FIG. 1 and pixel 2 of FIG. 2.

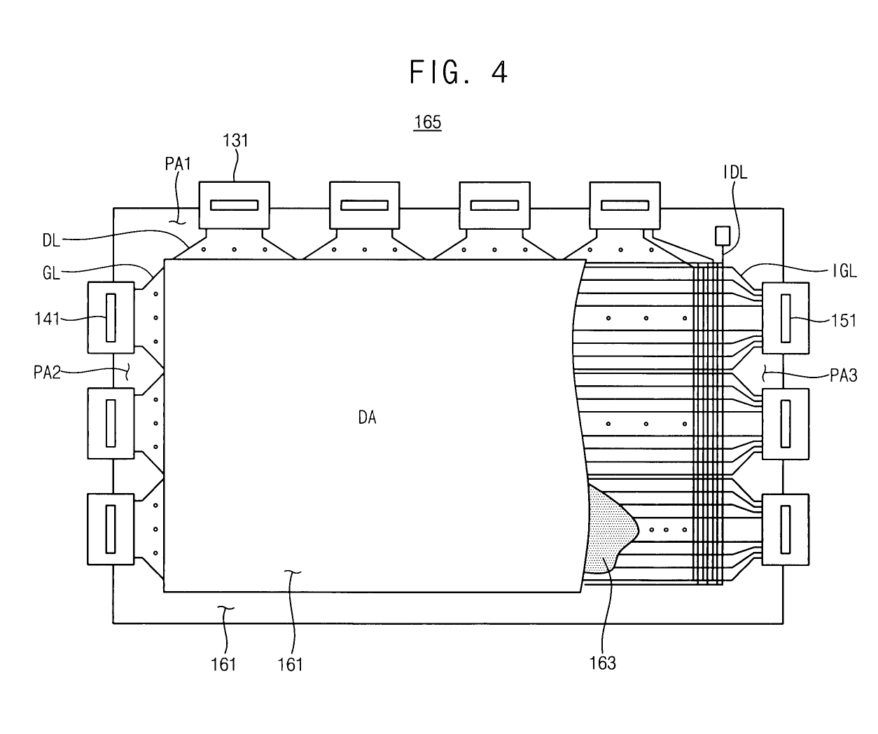

FIG. 4 is a plan view showing a display panel of the LCD device shown in FIG. 3.

Referring to FIG. 4, the display panel 165 includes a first substrate 161, a second substrate 162 and a liquid crystal layer 163 interposed between the first and second substrates 161 and 162.

The first substrate 161 includes a display region DA, a first peripheral region PA1, a second peripheral region PA2 and a third peripheral region PA3. As shown in FIG. 4, the first, second and third peripheral regions PA1, PA2 and PA3 are exterior to the display region DA.

A plurality of data lines DL that are extended in a first direction, a plurality of impulse data lines IDL 20 that are extended in the first direction, a plurality of gate lines GL that are extended in a second direction, and a plurality of impulse gate lines IGL that are extended in the second direction are formed in the display area DA. The second direction crosses the first direction. A plurality of unit pixels is defined by the data and gate lines DL and GL. In FIG. 4, the display panel 165 includes the impulse data lines IDL 20 as shown in FIG. 1. Alternatively, the impulse data lines IDL may be omitted, and a common voltage line may be used for the impulse data lines as shown in FIG. 2.

A plurality of data tape carrier packages (TCPS) 131, each of which has a data driving chip, is provided in the first peripheral region PA1. The data driving chips apply data voltages to the data lines DL, respectively. A plurality of first gate TCPs 142, each of which has a first gate driving chip, is formed in the second peripheral region PA2. The first gate driving chips apply gate signals to the gate lines GL, respectively. A plurality of second gate TCPs 153, each of which has a second gate driving chip, is formed in the third peripheral region PA3. The second gate driving chips apply impulse gate signals to the impulse gate lines IGL, respectively.

Output terminals of the second gate TCPs 153 are electrically connected to the impulse gate lines IGL, respectively.

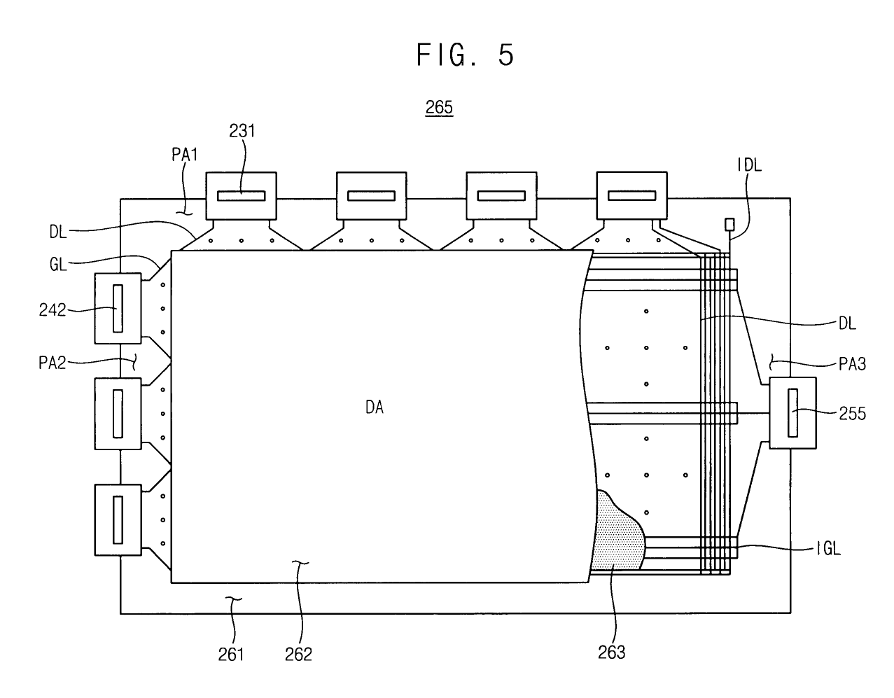

FIG. 5 is a plan view showing a display panel in accordance with another embodiment of the present invention. The display panel illustrated in FIG. 5 is same as in FIG. 4, except that second gate TCPs have been omitted. Thus, the same reference numerals will be used to refer to the same or like parts as those described in FIG. 4 and further explanation concerning the above elements may be omitted.

Referring to FIG. 5, the display panel 265 includes a first substrate 261, a second substrate 262 and a liquid crystal layer 263 interposed between the first and second substrates 261 and 262.

The first substrate 261 includes a display region DA, a first peripheral region PA1, a second peripheral region PA2 and a third peripheral region PA3. As shown in FIG. 5, the first, second and third peripheral regions PA1, PA2 and PA3 are external to the display region DA.

A plurality of data lines DL that are extended in a first direction, a plurality of impulse data lines IDL that are extended in the first direction, a plurality of gate lines GL that are extended in a second direction, and a plurality of impulse gate lines IGL that are extended in the second direction are formed in the display area DA. The second direction crosses the first direction. A plurality of unit pixels is defined by the data and gate lines DL and GL.

In FIG. 5, the display panel 265 includes impulse data lines IDL such as those shown in FIG. 1. Alternatively, the impulse data lines IDL may be omitted, and a common voltage line may be used for the impulse data lines (as shown in FIG. 2).

A plurality of data tape carrier packages (TCPs) 231 is provided in the first peripheral region PA1. A plurality of first gate TCPs 242 is provided in the second peripheral region PA2. A plurality of second gate TCPs 255 that apply impulse gate signals to the impulse gate lines IGL is provided in the third peripheral region PA3.

Each of output terminals of the second gate TCPs 255 is electrically connected to a portion of the impulse gate lines IGL. That is, each of the output terminals of the second gate TCPs 255 is electrically connected to the portion of the impulse gate lines IGL of a predetermined number.

As a result, the number of the second gate TCPs 255 and the number of second gate driving chips may both be decreased. For the example illustrated in FIG. 5, each of the output terminals of the second gate TCPs 255 is electrically connected to three impulse gate lines IGL. Therefore, the number of the second gate TCPs 255 of the display panel of FIG. 5 is one third of the number of the second gate TCPs of the display panel of FIG. 4.

In the examples shown in FIGS. 4 and 5, the gate driving chips are mounted on the display panel using the gate TCPs. Alternatively, a plurality of gate driving circuits having amorphous silicon thin film transistors (for example) may be directly formed in the peripheral region of the display panel.

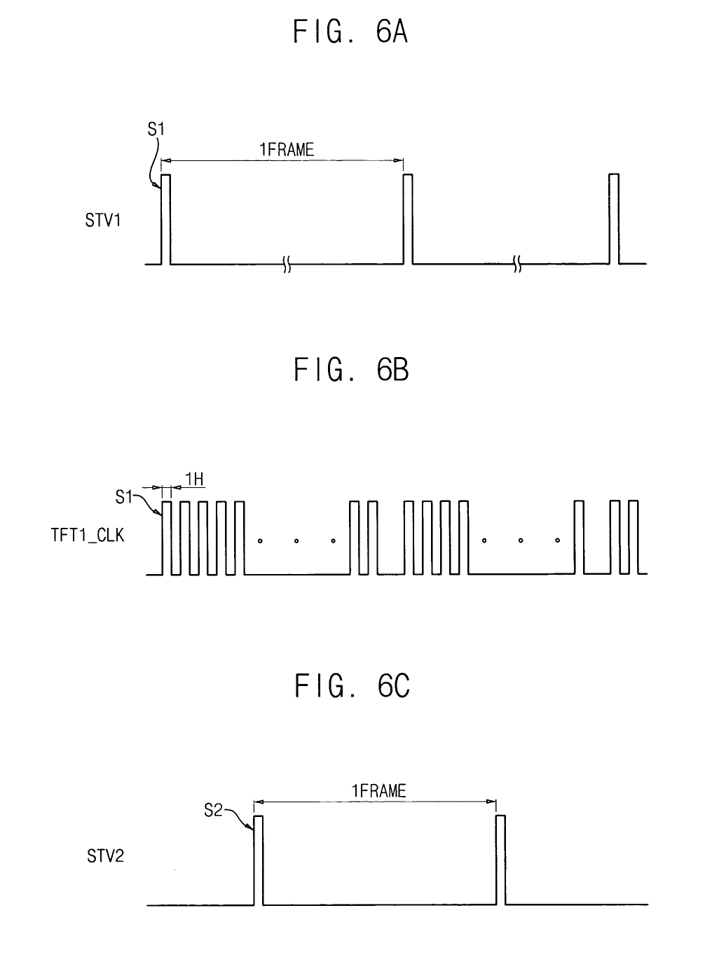

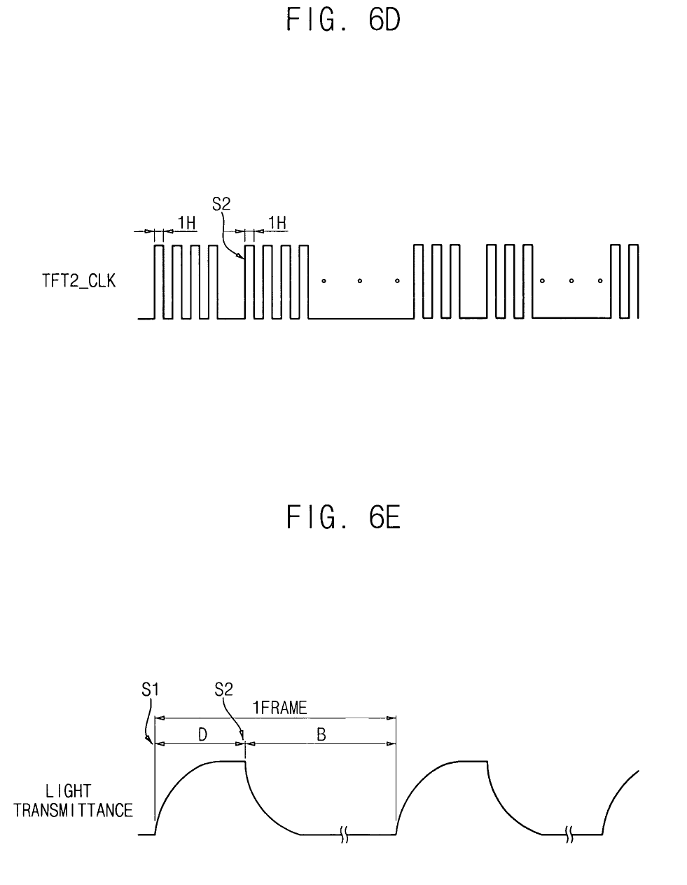

FIGS. 6A to 6E are timing diagrams showing a method of impulsive driving in accordance with some embodiments of the present invention.

Referring to FIGS. 3, 4, 6A and 6B, a timing control circuit 110 applies a first scan start signal STV1 to a gate driver circuit 140.

When the first scan start signal STV1 in a high state S1 is applied to the gate driver circuit 140, the gate driver circuit 140 outputs N gate signals G1, G2, . . . GN, in sequence. That is, the gate driver circuit 140 outputs N gate signals G1, G2, . . . GN in one frame. Each of the gate signals G1, G2, . . . GN corresponds to one horizontal period 1H.

The gate signals G1, G2, . . . GN are applied to gate lines GL1, GL2, . . . GLN of an LCD panel 160, in sequence, to turn on first switching elements TFT1. When the first switching elements TFT1 are turned on, data voltages are stored in liquid crystal capacitors CLC to display normal image gray-scales corresponding to the data voltages, respectively.

Referring to FIGS. 3, 4, 6C and 6D, a timing control circuit 110 applies a second scan start signal STV2 to an impulse driver circuit 150. The second scan start signal STV2 is delayed with respect to the first scan start signal STV1 by a predetermined delay amount.

When the second scan start signal STV2 in a high state S2 is applied to the impulse driver circuit 150, the impulse driver circuit 150 outputs N impulse gate signals IG1, IG2, . . . IGN, in sequence. That is, the impulse driver circuit 150 outputs N impulse gate signals IG1, IG2, . . . IGN in the one frame. Each of the impulse gate signals IG1, IG2, . . . IGN corresponds to one horizontal period 1H.

The impulse gate signals IG1, IG2, . . . IGN are applied to impulse gate lines IGL1, IGL2, . . . IGLN of the LCD panel 160, in sequence, to turn on second switching elements TFT2. When the second switching elements TFT2 are turned on, the data voltages stored in the liquid crystal capacitors CLC are discharged. That is, when the second switching elements TFT2 are turned on, the impulse voltages are stored in the liquid crystal capacitors CLC to display impulse gray-scales corresponding to the impulse voltages, respectively.

FIG. 6E is a timing diagram showing a light transmittance of a unit pixel in an implementation of an impulsive driving system. Referring to FIG. 6E, the first scan start signal STV1 of the high state S1 is outputted to the gate driver circuit 140 so that the light transmittance is high during a normal display period ‘D’. The second scan start signal STV2 of the high state S2 is outputted to the impulse driver circuit 150 so that the light transmittance is low during an impulse display period ‘B’ that is a period after the normal display period ‘D’. The normal display period ‘D’ and the impulse display period ‘B’ form the one frame.

In impulsive driving, the normal and impulse display periods D and B are alternately repeated to improve a display quality of a moving image. In FIG. 6E, a frequency of each of the first and second scan start signals STV1 and STV2 is about 60 Hz.

In addition, the delay amount between the first and second scan start signals STV1 and STV2 is changed to control a ratio of the normal display period D to the impulse display period B.

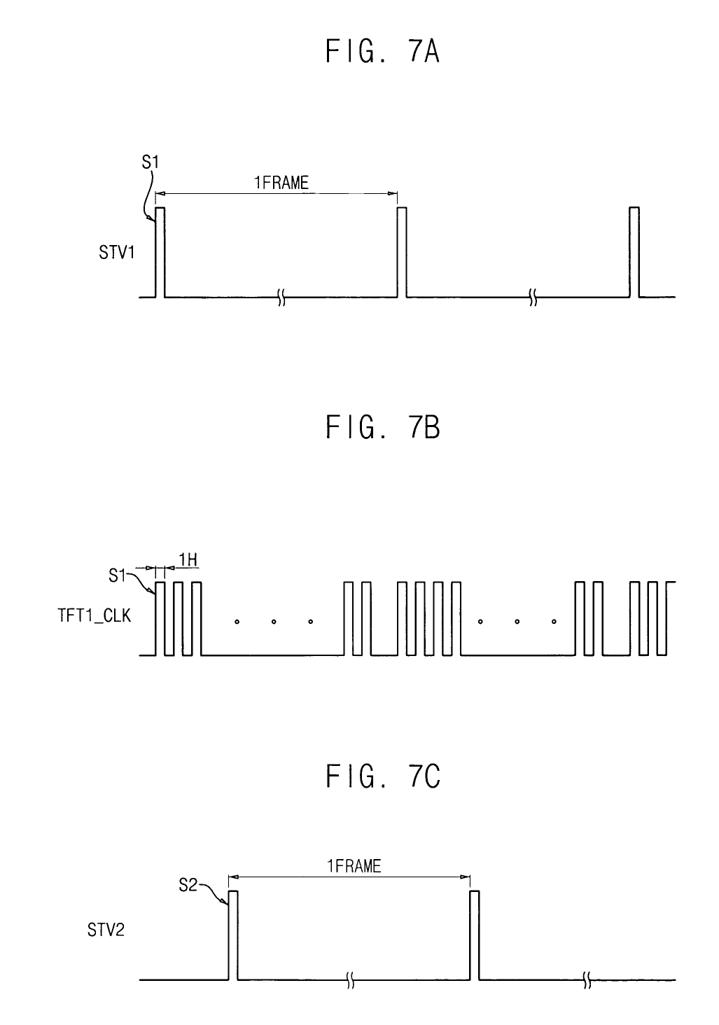

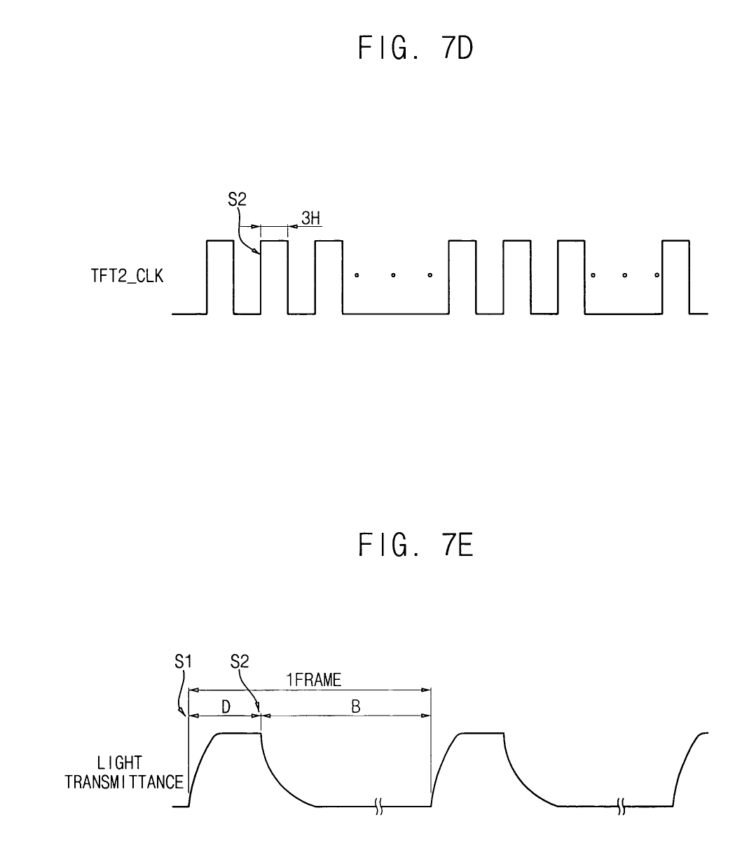

FIGS. 7A to 7E are timing diagrams showing a method of impulsive driving in accordance with another embodiment of the present invention.

Referring to FIGS. 3, 5, 7A and 7B, a timing control circuit 110 applies a first scan start signal STV1 to a gate driver circuit 140.

When the first scan start signal STV1 in a high state S1 is applied to the gate driver circuit 140, the gate driver circuit 140 outputs N gate signals G1, G2, . . . GN, in sequence. Each of the gate signals G1, G2, . . . GN corresponds to one horizontal period 1H.

The gate signals G1, G2, . . . GN are applied to gate lines GL1, GL2, . . . GLN of an LCD panel 160, in sequence, to turn on first switching elements TFT1. When the first switching elements TFT1 are turned on, data voltages are stored in liquid crystal capacitors CLC to display normal image gray-scales corresponding to the data voltages, respectively.

Referring to FIGS. 3, 5, 7C and 7D, a timing control circuit 110 applies a second scan start signal STV2 to an impulse driver circuit 150. The second scan start signal STV2 is delayed with respect to the first scan start signal STV1 by a predetermined delay amount.

When the second scan start signal STV2 in a high state S2 is applied to the impulse driver circuit 150, the impulse driver circuit 150 outputs ‘N’ impulse gate signals IG1, IG2, . . . IGN.

Referring again to FIG. 5, a q-th impulse gate signal IGq is applied to (3q-2)th, (3q-1)th and 3q-th impulse gate lines IGL(3q-2), IGL(3q-1) and IGL(3q), in common. That is, the q-th impulse gate signal IGq is simultaneously applied to the (3q-2)th, (3q-1)th and 3q-th impulse gate lines IGL(3q-2), IGL(3q-1) and IGL(3q). The impulse gate signals IG1, IG2, . . . IGN are grouped into a plurality of impulse gate signal groups. Each of the impulse gate signal groups includes three impulse gate signals. The three impulse gate signals are simultaneously applied to three impulse gate lines.

A portion of the second switching elements TFT2 electrically connected to the three impulse gate lines is turned on to discharge the data voltages stored in the liquid crystal capacitors CLC corresponding to the portion of the second switching elements TFT2. That is, when the portion of the second switching elements TFT2 electrically connected to the three impulse gate lines is turned on, the impulse voltages are stored in the liquid crystal capacitors CLC corresponding to the portion of the second switching elements TFT2 to display impulse gray-scales corresponding to the impulse voltages, respectively.

FIG. 7E is a timing diagram showing a light transmittance of a unit pixel in an impulsive driving. Referring to FIG. 7E, the first scan start signal STV1 of the high state S1 is outputted to the gate driver circuit 140 so that the light transmittance is high during a normal display period ‘D’. The second scan start signal STV2 of the high state S2 is outputted to the impulse driver circuit 150 so that the light transmittance is low during an impulse display period ‘B’ that is a period after the normal display period ‘D’. The normal display period ‘D’ and the impulse display period ‘B’ form the one frame.

In the impulsive driving, the normal and impulse display periods D and B are alternately repeated to improve a display quality of a moving image. In FIG. 7E, a frequency of each of the first and second scan start signals STV1 and STV2 is about 60 Hz.

In addition, the delay amount between the first and second scan start signals STV1 and STV2 is changed to control a ratio of the normal display period D to the impulse display period B.

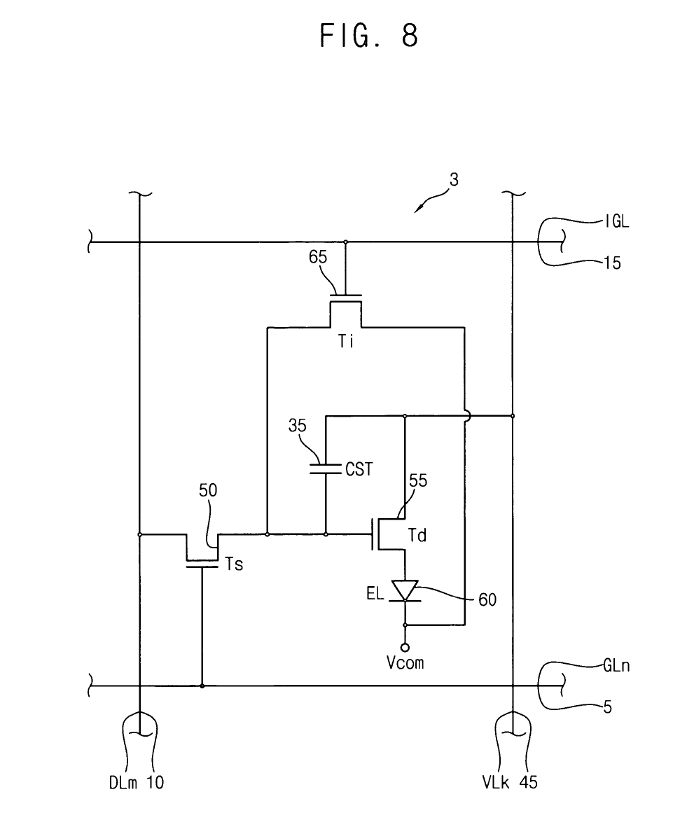

FIG. 8 is a circuit diagram showing a unit pixel 3 of a display panel in accordance with another embodiment of the present invention.

Referring to FIG. 8, unit pixel 3 is defined by a gate line GLn 5, a data line DLm 10, a bias voltage line VLk 45 and an impulse gate line IGL 15.

The unit pixel 3 includes a switching element Ts 50, a driving element Td 55, an organic light emitting element EL 60, a storage capacitor CST 35 and an impulse driving element Ti 65.

The switching element Ts 50 includes a gate electrode electrically connected to the gate line GLn 5, a source electrode electrically connected to the data line DLm 10, and a drain electrode electrically connected to the driving element Td 55.

The driving element Td 55 includes a gate electrode electrically connected to the switching element Ts 50, a source electrode electrically connected to the bias voltage line VLk 45, and a drain electrode electrically connected to the organic light emitting element EL 60.

The organic light emitting element EL 60 includes a first end electrically connected to the driving element Td 55, and a second end electrically connected to a common voltage line (not shown) that transmits a common voltage Vcom.

The storage capacitor CST 35 includes a first end electrically connected to the bias voltage line VLk 45, and a second end electrically connected to the switching element Ts 50 and the driving element Td 55.

The impulse driving element Ti 65 includes a gate electrode electrically connected to the impulse gate line IGL 15, a source electrode electrically connected to the common voltage line (not shown) that transmits the common voltage Vcom to the organic light emitting element EL 60, and a drain electrode electrically connected to the driving element Td 55.

The unit pixel 3 described above is operated as follows.

When a gate signal is applied to the gate electrode of the switching element Ts 50 through the gate line GLn 5, the switching element Ts 50 is turned on so that a data voltage that is applied to the data line DLm 10 is applied to the driving element Td 55. The data voltage applied to the driving element Td 55 is applied to the organic light emitting element EL 60. The organic light emitting element EL 60 generates light based on the data voltage. The unit pixel 3 displays a normal gray-scale corresponding to the data voltage.

An impulse gate signal is applied to the impulse gate line IGL 15 after a predetermined time period. When the impulse gate signal is applied to the impulse gate line. IGL 15, the impulse driving element Ti 65 is turned on so that the common voltage Vcom is applied to the driving element Td 55. The common voltage Vcom that is applied to the driving element Td 55 is applied to the organic light emitting element EL 60, and the organic light emitting element EL 60 is turned off in response to the common voltage Vcom. That is, the organic light emitting element EL 60 is discharged based on the common voltage Vcom. The common voltage Vcom functions as an impulse voltage to display a black gray-scale.

In FIG. 8, the common voltage Vcom is used as the impulse voltage. Alternatively, the display panel may further include an impulse voltage line that transmits the impulse voltage.

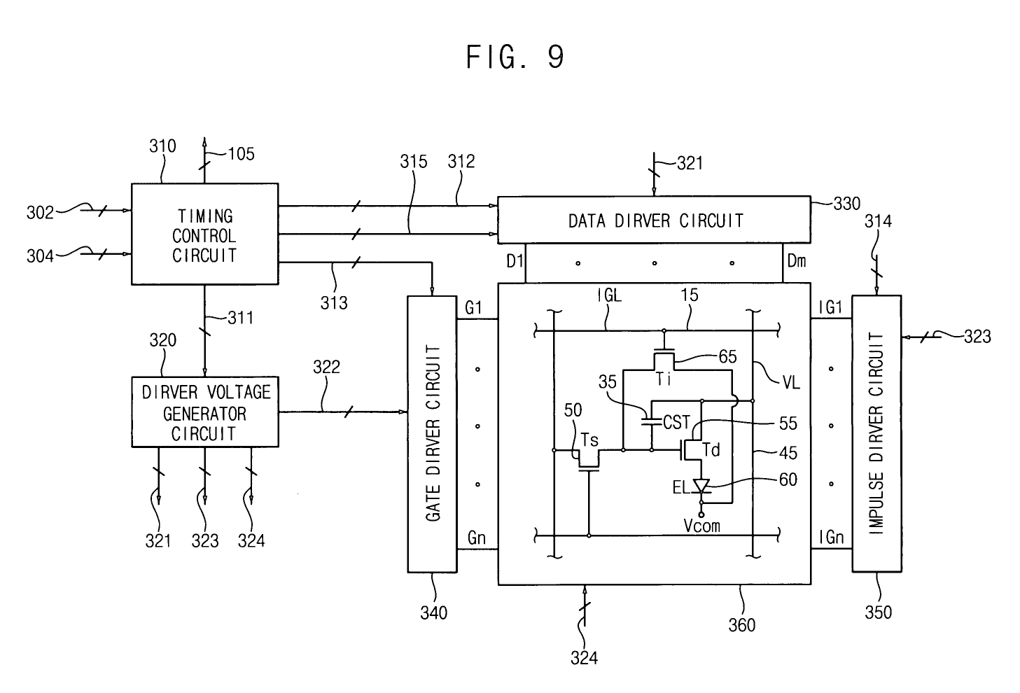

FIG. 9 is a block diagram showing an organic light emitting display (OLED) device in accordance with another embodiment of the present invention.

Referring to FIG. 9, the OLED device includes a timing control circuit 310, a driving voltage generator circuit 320, a data driver circuit 330, a gate driver circuit 340, an impulse driver circuit 350 and an OLED panel 360.

The timing control circuit 310 outputs a first control signal on a bus 311, a second control signal on a bus 312, a third control signal on a bus 313 and a fourth control signal on a bus 314 based on control signals received on a bus 302 having a driving frequency. The control signals received on bus 302 may be provided from outside of the OLED device. In the OLED device shown in FIG. 9, the driving frequency is about 60 Hz to about 75 Hz.

The timing control circuit 310 converts primary data 304 that is provided from the outside of the OLED device into image data 315.

The timing control circuit 310 provides the first control signal to the driving voltage generator circuit 320 over bus 311. The timing control circuit 310 provides the second signal to the data driver circuit 330 over bus 312. The timing control circuit 310 applies the third control signal to the gate driver circuit 340 on bus 313. The timing control circuit 310 provides the fourth control signal to the impulse driver circuit 350 over bus 314.

The third control signal on bus 313 includes a first scan start signal STV1 shown in FIG. 6A, a first scan clock signal CPV1 (not shown) and a first output enable signal OE1 (not shown). The fourth control signal on bus 314 includes a second scan start signal STV2 shown in FIG. 6C, a second scan clock signal CPV2 (not shown) and a second output enable signal OE2 (not shown).

The driving voltage generator circuit 320 generates driving voltages for driving the data driver circuit 330, the gate driver circuit 340, the impulse driver circuit 350 and the OLED panel 360 based on the first control signal 311. In particular, the driving voltage generator circuit 320 provides a reference gray-scale voltage over bus 321 to data driver circuit 300, a first gate voltage over bus 322 to the gate d river circuit, and a second gate voltage over bus 323 to the impulse driver circuit 350. The driving voltage generator circuit 320 applies a common voltage Vcom for an organic light emitting element EL and a bias voltage Vdd (not shown) to the OLED panel 360.

Alternatively, when the OLED panel 360 includes a unit pixel such as pixel 1 of FIG. 1, the driving voltage generator circuit 320 also applies an impulse voltage to an impulse data line IDL 20.

The data driver circuit 330 generates analog type data voltages D1, D2, . . . Dm based on the second control signal received over bus 312. The data driver circuit 330 applies the analog type data voltages D1, D2, . . . Dm to the data lines of the OLED panel 360.

The gate driver circuit 340 generates gate signals G1, G2, . . . Gn based on the third control signal received over 313 and the first gate voltages received over bus 322. The gate driver circuit 340 applies the gate signals G1, G2, . . . Gn to the gate lines of the OLED panel 360.

The impulse driver circuit 350 generates impulse gate signals IG1, IG2, . . . IGn based on the fourth control signal 314 and the second gate voltages 323. The impulse driver circuit 350 applies the impulse gate signals IG1, IG2, . . . IGn to the impulse gate lines IGL 15 of the OLED panel 360.

The second scan start signal STV2 shown in FIG. 6C of the third control signal 313 is delayed with respect to the first scan start signal STV1 shown in FIG. 6A of the fourth control signal 314 by a predetermined delay amount. The delay amount is shorter than one frame. The impulse gate signals IG1, IG2, . . . IGn, which are initiated after the second scan start signal STV2 shown in FIG. 6C, are delayed with respect to the gate signals G1, G2, . . . Gn, which are initiated after the first scan start signal STV1 shown in FIG. 6A, by the delay amount, respectively. Therefore, a normal image that is displayed using the data voltage and an impulse image that is displayed using the impulse voltage are displayed on the OLED panel 360 in one frame.

In the OLED device of FIG. 9 includes pixels such as unit pixel 3 shown in FIG. 8. Alternatively, the O LED device of FIG. 9 may also include u nit pixels such a s those shown in FIG. 1 or FIG. 2.

The OLED device of FIG. 9 may be driven through the impulse method shown in FIGS. 6A to 6E. Alternatively, the OLED device of FIG. 9 may also be driven through the impulse method shown in FIGS. 7A to 7E.

According to some embodiments of the present invention, the driving element for impulse driving is formed in the unit pixel. Thus, impulse driving may be performed without increasing the driving speed of the display device, thereby increasing a driving margin of the display device. As a result, the display quality of moving images may be improved.

This invention has been described with reference to the embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display panel comprising:
a liquid crystal capacitor in a region of the display panel, the region defined by a first gate line and a first data line, the first gate line adjacent to the first data line;
a switching element configured to transmit a data voltage to the liquid crystal capacitor in response to a gate voltage, the data voltage provided by the data line, the gate voltage provided by the gate line;
a storage capacitor electrically connected to the liquid crystal capacitor;
an impulse gate line configured to transmit an impulse gate signal; and
an impulse driving element configured to transmit a common voltage to the liquid crystal capacitor in response to the impulse gate signal, the common voltage further being applied to the storage capacitor.

2. The display panel of claim 1, wherein the impulse gate line is substantially parallel to the gate line_{[LGG4}].

3. The display panel of claim 1, wherein the impulse driving element comprises a gate electrode electrically connected to the impulse gate line, a source electrode electrically connected to the liquid crystal capacitor, and a drain electrode electrically connected to the liquid crystal capacitor.

4. The display panel of claim 1, further comprising an impulse line substantially parallel to the data line, the impulse line configured to receive an impulse voltage, wherein the impulse driving element is configured to transmit the impulse voltage to the liquid crystal capacitor in response to the impulse gate signal.

5. The display panel of claim 4, wherein the impulse driving element comprises a gate electrode electrically connected to the impulse gate line, a source electrode electrically connected to the impulse line, and a drain electrode electrically connected to the liquid crystal capacitor.

6. A display panel comprising:
an organic light emitting element in a region defined by a first gate line, a first data line, and a power voltage line, the first gate line adjacent the first data line, the organic light emitting element in communication with a common voltage;
an impulse gate line configured to transmit an impulse gate signal;
a driving element configured to drive the organic light emitting element;
a switching element configured to transmit a data voltage to the driving element in response to a gate voltage, the data voltage provided by the first data line, the gate voltage provided by the first gate line; and
an impulse driving element configured to transmit the common voltage to the driving element in response to the impulse gate signal.

7. The display panel of claim 6, wherein the impulse driving element comprises a gate electrode electrically connected to the impulse gate line, a source electrode electrically connected to a common voltage, and a drain electrode electrically connected to the driving element.

8. The display panel of claim 6, further comprising an impulse line substantially parallel to the data line, the impulse line configurerd to receive an impulse voltage, wherein the impulse driving element is configured to transmit the impulse voltage to the driving element in response to the impulse gate signal.

9. The display panel of claim 8, wherein the impulse driving element comprises a gate electrode electrically connected to the impulse gate line, a source electrode electrically connected to the impulse line, and a drain electrode electrically connected to the driving element.

10. A display device comprising:
a voltage generator configured to output an impulse voltage;
a data driver configured to output a data voltage;
a controller configured to output a first control signal and a second control signal based on a driving frequency, the second control signal being delayed with respect the first control signal by a delay amount;
a gate driver configured to output a gate signal in response to the first control signal;
an impulse driver configured to output an impulse gate signal in response to the second control signal; and
a display panel configured to display a normal gray-scale corresponding to the data voltage in response to the gate signal during a first period of a frame, and further configured to display an impulse gray-scale corresponding to the impulse voltage in response to the impulse gate signal during a second period of the frame.

11. The display device of claim 10, wherein the first control signal comprises a first scan start signal, and wherein the second control signal comprises a second scan start signal.

12. The display device of claim 10, wherein the driving frequency is included in a frequency range of about 60 Hz to about 80 Hz.

13. The display device of claim 10, wherein the display panel comprises:
a liquid crystal capacitor configured to store a gray-scale voltage;
a first switching element configured turn on in response to the gate signal, and wherein the data voltage is stored in the liquid crystal capacitor in response to the first switching element turning on; and
a second switching element configured to turn on in response to the impulse gate signal, and wherein the impulse voltage is stored in the liquid crystal capacitor in response to the second switching element turning on.

14. The display device of claim 13, wherein the display panel further comprises a storage capacitor, and wherein the impulse voltage is a common voltage of the storage capacitor.

15. The display device of claim 14, wherein the display panel has a normally black mode so that a black gray-scale is displayed when the display panel does not receive any voltage.

16. The display device of claim 10, wherein the display panel comprises:
an organic light emitting element configured to display a gray-scale;
a driving element configured to drive the organic light emitting element;
a switching element configured to turn on and transmit the data voltage to the driving element in response to the gate signal; and
an impulse driver circuit configured to turn on and transmit the impulse voltage to the driving element in response to the impulse gate signal.

17. The display device of claim 16, wherein the impulse voltage is a common voltage applied to the organic light emitting element.

18. The display device of claim 10, wherein the timing controller is configured to control the delay amount to adjust a ratio of the first period to the second period.

19. The display device of claim 10, wherein the display panel comprises a plurality of gate lines, and the gate impulse signal is simultaneously applied to at least two adjacent gate lines.

20. A method of driving a display device comprising:
outputting a data signal;
outputting an impulse signal;
outputting a gate signal to a first data switch associated with a first pixel;
at the first pixel, displaying a normal gray-scale indicative of the data signal in response to the gate signal during a first period of a frame;
outputting an impulse gate signal to a first impulse switch associated with the first pixel, the impulse gate signal delayed with respect to the gate signal by a delay amount; and
at the first pixel, displaying an impulse gray-scale indicative of the impulse signal in response to the impulse gate signal during a second period of the frame.

21. The method of claim 20, further comprising:
outputting a different data signal;
outputting a different gate signal to a second data switch associated with a second pixel different from the first pixel during the first period of the frame; and
outputting the impulse gate signal or a different impulse gate signal to a second impulse switch associated with the second pixel during the second period of the frame.

22. The method of claim 21, wherein outputting the impulse gate signal or a different impulse gate signal to a second impulse switch associated with the second pixel during the second period of the frame comprises outputting the impulse gate signal to the second impulse switch associated with the second pixel during the second period of the frame.

23. A display apparatus comprising:
a first pixel region of the display apparatus, the first pixel region comprising switching circuitry, the switching circuitry configured to provide a data voltage to the first pixel region during a first portion of a frame, the switching circuitry further configured to provide an impulse voltage to the first pixel region during a second portion of the frame; and
a second pixel region of the display apparatus, the second pixel region comprising different switching circuitry, the different switching circuitry configured to provide a different data voltage to the second pixel region during the first portion of the frame.

24. The apparatus of claim 23, wherein the different switching circuitry is further configured to provide the impulse voltage to the second pixel region during the second portion of the frame.

25. The apparatus of claim 23, wherein the switching circuitry comprises a data switch and an impulse switch separate from the data switch.

26. The apparatus of claim 25, wherein the data switch comprises a thin film transistor and wherein the impulse switch comprises a different thin film transistor.

27. The apparatus of claim 23, wherein the first pixel region comprises a liquid crystal pixel region, and wherein the switching circuitry is configured to provide the data voltage to the first pixel region during the first portion of the frame by transmitting the data voltage to a liquid crystal capacitor.

28. The apparatus of claim 27, wherein the switching circuitry is configured to provide the impulse voltage to the first pixel region during the second portion of the frame by transmitting the impulse voltage to the liquid crystal capacitor.

29. The apparatus of claim 28, wherein a charge on the liquid crystal capacitor is substantially discharged during the second portion of the frame.
